(19) United States
(12) Patent Application Publication
(10) Pub. No.: US 2023/0365754 A1
(43) Pub. Date: Nov. 16, 2023

(54) CROSS-LINKABLE ALLYLAMIDO POLYMERS

(71) Applicants: Universiteit Gent, Gent (BE); Queensland University of Technology, Brisbane (AU)

(72) Inventors: Richard HOOGENBOOM, Terneuzen (NL); Tim DARGAVILLE, Brisbane (AU)

(21) Appl. No.: 18/028,397

(22) PCT Filed: Oct. 19, 2021
(86) PCT No.: PCT/EP2021/079003

§ 371 Date: Apr. 28, 2023

(30) Foreign Application Priority Data
Oct. 19, 2020 (EP) 20202622.5

(51) Int. Cl. C08G 73/02; C08J 3/075; C09D 11/102; C09D 179/02

(52) U.S. Cl. CPC C08G 73/0233; C08J 3/075; C09D 11/102; C09D 179/02; C08J 2379/02

(57) ABSTRACT

The present invention relates to combinations of a poly(2-oxazoline) or poly(2-oxazine)5 polymer or copolymer having an allylamido side chain and a cross-linker, cross-linked compositions thereby obtained and hydrogels thereof. Further, the present invention discloses methods of providing the combination, compositions and hydrogels described herein and their use.

### FIELD OF THE INVENTION

The present invention relates to the field of polymer chemistry and hydrogels. More specifically, it relates to combinations comprising a polymer having an allylamido side chain and a cross-linker, cross-linked compositions thereby obtained and hydrogels thereof. Further, the present invention discloses methods of providing the combination, compositions and hydrogels described herein and their use.

The present invention in particular relates to combinations of a poly(2-oxazoline) or poly(2-oxazine) polymer or copolymer having an allylamido side chain and a cross-linker, cross-linked compositions thereby obtained and hydrogels thereof. Further, the present invention discloses methods of providing the combination, compositions and hydrogels described herein and their use.

### BACKGROUND TO THE INVENTION

Hydrogels are physically or chemically cross-linked polymer networks that are capable of absorbing large amounts of water. In other words, hydrogels are compositions comprising natural or synthetic polymeric matrixes. In nature, types of hydrogels include collagen, hyaluronic acid and others. In the past decades, scientists focused on improving the characteristics of natural hydrogels and also providing synthetic hydrogels to be used in a variety of applications. Hydrogels have currently widespread applications in the food and pharmaceutical industry and proved useful in bioengineering applications such as tissue engineering, where it is required that hydrogels are chemically stable and possess compatible mechanical properties under physiological conditions.

As previously mentioned, hydrogels are characterized by the presence of a polymer network, or matrix, which provides for the swelling properties. Said polymer network is obtained by cross-linking cross-linkable groups attached to the polymeric backbone, either a homopolymer, a copolymer. In order to accomplish the cross-linking, various cross-linking methods exists.

The cross-linking methods in the state of the art can be divided in mainly two categories: physical and chemical. Among these methods, chemical cross-linking methods provide for the formation of covalent bonds between polymeric chains, this resulting in more stable hydrogels and more controllable mechanical properties. In particular, the use of photo-crosslinking strategies is of specific interest as these methods are generally characterized by relatively mild conditions allowing e.g. cell encapsulation in the hydrogel. Photo-crosslinking can be achieved by exposing various types of photo-reactive functional groups to electromagnetic radiation e.g. UV light. Among the various chemistries available, thiol-ene chemistry gained interests over the last decades, due to its versatility.

Thiol-ene chemistry is a versatile tool for creating carbon-sulfur bonds and has been used extensively to create cross-linked structures with both commercial and research value. The thiol-ene coupling reactions are advantageous, as (1) they are considered to be insensitive to oxygen inhibition, (2) can be performed in a single step under a wide range of conditions, including in aqueous media, (3) can be performed in the presence of cells without deleterious effects, and can be formed from any range of free thiols and accessible vinyl groups.

In thiol-ene coupling reactions for the formation of hydrogels, it is useful to start with medium to high molar mass macromolecular precursors. These should contain either the thiol or ene groups (e.g. alkene or allyl moieties) and cross-link with a second small molecule or macromolecule containing the corresponding reactive thiol groups.

In the creation of hydrogels, the selection of the polymeric backbone of the cross-linked polymer networks determines the final properties of the hydrogel. Based on the desired application of the hydrogel, a polymeric backbone can be more suitable than another. Some of the desirable attributes targeted when developing new cross-linkable polymers for biomedical applications are cytocompatibility, minimal foreign body response (FBR), high yielding rapid cross-linking under mild conditions, few or no side reactions, simple formulation, and availability of cheap and readily available or easily synthesized starting materials. Polymeric backbones can comprise natural polymers such as collagen and gelatin, or synthetic polymers such as PEG, polysaccharides, proteins, peptides, growth factors and others.

Previous work by Hoogenboom et al., 2009, taking into consideration of many of these properties has been aimed at developing new hydrogels based on poly(2-alkyl-2-oxazoline)s (PAOx). The rationale behind using PAOx over other non-ionic, hydrophilic materials is their rich chemistry, relatively straight-forward synthesis and potential biocompatibility. A more detailed discussion highlighting the attractiveness of PAOx as a base material for hydrogels has been recently published (Dargaville et al., 2018). Also poly(2-oxazine)s (PAOzi) based polymer materials have been highlighted in literature as promising materials in drug delivery systems (DDS) and polymer therapeutics. As PAOx, PAOzi offer wider synthetic variability allowing to more precisely design the polymer carrier architecture to achieve control over its biological behavior. Superior hydrophilicity of both PAOx and PAOzi polymers, in particular PMeOx and PMeOzi, leads to their better anti-fouling properties compared to PEG see Sedlacek, O et al., 2020.

Over the past several years Hoogenboom et al., have developed hydrophilic PAOx copolymers incorporating alkene-terminated alkyl side chains using 2-undecenyl-2-oxazoline (DecenOx) or 2-butenyl-2-oxazoline (ButenOx) copolymerized with 2-methyl-2-oxazoline (MeOx) or 2-ethyl-2-oxazoline (EtOx). These polymers can be cross-linked by any number of dithiol molecules via thiol-ene coupling.

Dargaville et al., 2016, describe the synthesis of hydrogels based on PAOx. These hydrogels have been found advantageous in many applications, especially biomedical applications, playing a key role in the construction of systems for drug/gene delivery or tissue engineering. In particular, PAOx provide a full control over the achievable polymer architectures, including blocks, gradients, and star-shaped structure. Furthermore, the properties of PAOx are highly tunable by variation of the side chain group as well as by copolymerization of different monomers. Dargaville et al., 2016, describe that hydrophobic cross-linkable groups containing terminal double bonds, namely decenyl (providing DecenOx), can be cured more rapidly than those having shorter, more hydrophilic groups, more specifically butenyl (providing ButenOx). Further, Dargaville et al., ascribe that the faster curing of hydrophobic cross-linkable groups can be the result of hydrophobic associations of such hydrophobic cross-linkable groups, which determine a higher local double bond concentration, hence providing for a faster cross-linking.

Even though Dargaville et al., 2016, discloses groups capable of faster curing, their hydrophobic character renders them less compatible with polar solvents e.g. water, hence providing for a reduced compatibility with direct curing in said polar solvents. A higher compatibility with polar solvents of the photo-crosslinkable functional groups is especially desired in bioengineering applications, wherein water or aqueous solutions are the biocompatible solvent of choice. In other words, a disadvantage of these materials is that the hydrophobic side chains incorporating the alkene contribute significantly to the overall hydrophobicity of the polymers meaning to maintain water solubility they should be copolymerized with the more hydrophilic MeOx monomer or their concentration in the polymer should be kept low.

Therefore, there is the need of providing for hydrogels, compositions and combinations and methods thereof overcoming the drawbacks of the prior art. Further, the present invention, aims at providing hydrogels and compositions and combination thereof with improved curing properties and improved biocompatibility.

### SUMMARY OF THE INVENTION

In a first aspect, the present invention provides a combination comprising a polymer or copolymer having one or more allylamido side chains; and a cross-linker, wherein the polymer or copolymer is selected from poly(2-oxazoline) or poly(2-oxazine). It has been surprisingly found that the combination according to the present invention provides for a faster cross-linking. This finding is surprising in the fact that allyl side-chain moieties would be expected based on the prior art to provide for a slower curing compared to moieties comprising terminal double bonds of increased length, such as decenyl and butenyl. Dargaville et al., 2016, ascribe that the faster curing of the more hydrophobic cross-linkable groups such as decenyl can be the result of hydrophobic associations of such hydrophobic cross-linkable groups, which determine a higher local double bond concentration, hence providing for a faster cross-linking. Therefore, polymers comprising, e.g. decenyl (providing DecenOx), can be cured more rapidly than those having shorter, more hydrophilic groups, more specifically butenyl (providing ButenOx).

In a further embodiment, the cross-linker comprises two or more thiol groups.

In a further embodiment, said polymer or copolymer comprises monomeric units selected from: 2-methyl-2-oxazoline, 2-ethyl-2-oxazoline, 2-propyl-2-oxazoline, 2-methyl-2-oxazine, 2-ethyl-2-oxazine and 2-propyl-2-oxazine.

In an embodiment according to the present invention, the combination comprises a copolymer comprising first 2-oxazoline or 2-oxazine monomers having one or more allylamido side chains and second 2-oxazoline or 2-oxazine monomers not having allylamido side chains in a ratio from about 95-5 to 5-95, preferably from 70-30 to 10-90, more preferably 40-60 to 10-90.

In a further embodiment of the present invention, said polymer in the combination is represented by formula (I):

(X-Z)ₙ-backbone (I)
wherein:
X represents the allylamido side chain;
Z represents a direct bond or a spacer; and
backbone is a poly(2-oxazoline) or poly(2-oxazine) polymer or copolymer backbone;
and n is an integer, wherein n≥2.

In a specific embodiment according to the present invention, said polymer or copolymer in said combination has a degree of polymerization from about 50 to 1000, preferably 100 to 800, more preferably 200 to 500.

In a second aspect, the present invention provides a composition comprising a combination according to the present invention, wherein the allylamido side chain and the cross-linker are cross-linked to each other.

In a third aspect, the present invention provides a hydrogel comprising a composition as described by embodiments of the present invention.

In a fourth aspect, the present invention provides for a method providing a composition in accordance with the present invention, comprising the steps of: a) providing a combination as defined by the present invention; and b) curing the polymer with the cross-linker thereby obtaining said composition.

In a further aspect, the present invention provides a (bio)ink comprising the combination according to the present invention, and further the use of said (bio)ink for 3D printing, 2-photon polymerization, bioprinting or biomaterials.

In yet a further aspect, the present invention provides the combination, or the composition, or the hydrogel as described by other embodiments of the present invention, for use in human or veterinary medicine.

In yet a further aspect, the present invention provides the use of the combination, or the composition, or the hydrogel as described by other embodiments of the present invention, in one of: food industry, cosmetics, drug delivery, cell delivery, bio engineering applications.

### BRIEF DESCRIPTION OF THE DRAWINGS

With specific reference now to the figures, it is stressed that the particulars shown are by way of example and for purposes of illustrative discussion of the different embodiments of the present invention only. They are presented in the cause of providing what is believed to be the most useful and readily description of the principles and conceptual aspects of the invention. In this regard no attempt is made to show structural details of the invention in more detail than is necessary for a fundamental understanding of the invention. The description taken with the drawings making apparent to those skilled in the art how the several forms of the invention may be embodied in practice.

FIG. 1, also abbreviated as FIG. 1, illustrates the cationic ring-opening polymerization (CROP) mechanism of EtOx and C₃MestOx with an oxazolinium salt (2-phenyl-2-oxazolinium tetrafluoroborate (HPhOx-BF₄)) as initiator and piperidine as terminator.

FIG. 2, also abbreviated as FIG. 2, illustrates the allylamidation of the methyl ester side chains of P(EtOx-C₃MestOx) using 6 equivalents of allylamine and TBD as catalyst in CH₃CN.

FIG. 3, also abbreviated as FIG. 3, illustrates the curves of storage moduli (G′) of 10% PEAOx solutions with different thiol:ene ratios before and during irradiation with 365 nm UV light.

FIG. 4, also abbreviated as FIG. 4, illustrates the dependence of thiol-ene ratio on maximum storage moduli.

FIG. 5A, also abbreviated as FIG. 5A, illustrates the photocuring behavior of a decenyl functionalized poly(2-oxazoline) (P1DecenOx) and of an allylamido containing polymer in accordance with the present invention (P2EAOx), under equal conditions in the timeframe 0 to 500 s, clearly revealing the much faster curing behavior of the latter. FIG. 5B, also abbreviated as FIG. 5B, illustrates the photocuring behavior of the same polymers and under the same conditions of the ones described in FIG. 5A, for a shorter time frame, from 0 to 200 s.

FIG. 6A, also abbreviated as FIG. 6A, identifies the curing behavior of P1DecenOx three storage modulus values, G′-A at the start of the curing, G′-B at mid-curve and G′-C before plateau G′(max) is reached. FIG. 6B, also abbreviated as FIG. 6B, illustrates the difference in gelation time to reach G′-A, G′-B and G′-C as identified in FIG. 6A for P1DecenOx and P2EAOx.

FIG. 7A, also abbreviated as FIG. 7A, illustrates results of experiments comparing the curing properties of poly(allyl acrylamide) and poly(pentenyl acrylamide) copolymers, wherein the percentage of alkene (allyl or pentenyl) is 3%. The results show that the polymers comprising pentenyl terminal double bonds crosslink faster than polymers comprising the allyl moieties. FIG. 7B, also abbreviated as FIG. 7B, illustrates the results of similar experiments wherein the percentage of alkene (allyl or pentenyl) is 10%.

### DETAILED DESCRIPTION OF THE INVENTION

The present invention will now be further described. In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous. When describing the compounds of the invention, the terms used are to be construed in accordance with the following definitions, unless a context dictates otherwise.

The term “about” or “approximately” as used herein when referring to a measurable value such as a parameter, an amount, a temporal duration, and the like, is meant to encompass variations of +/−10% or less, preferably +/−5% or less, more preferably +/−1% or less, and still more preferably +/−0.1% or less of and from the specified value, insofar such variations are appropriate to perform in the disclosed invention. It is to be understood that the value to which the modifier “about” or “approximately” refers is itself also specifically, and preferably, disclosed.

As used in the specification and the appended claims, the singular forms “a”, “an”, and “the” include plural referents unless the context clearly dictates otherwise. By way of example, “a polymer” means one polymer or more than one polymer.

The compounds of the present invention can be prepared according to the reaction schemes provided in the examples hereinafter, but those skilled in the art will appreciate that these are only illustrative for the invention and that the compounds of this invention can be prepared by any of several standard synthetic processes commonly used by those skilled in the art of organic chemistry.

In a first aspect, the present invention provides a combination comprising a poly(2-oxazoline) polymer or copolymer having two or more allylamido side chains; and a cross-linker. In the context of the present invention, by means of the term “combination” as used herein is meant to be a selection of two or more chemical compositions or compounds. Accordingly, the combination of the present invention may thus comprise a polymer or copolymer as defined herein together with a cross-linker.

In the context of the present invention, a poly(2-oxazoline) polymer or copolymer is a polymer or copolymer comprising a polymer backbone derived from the ring-opening polymerization (ROP) product of 2-oxazoline or derivatives of 2-oxazoline thereof. In the context of the present invention, 2-oxazoline derivatives can be 2-Alkyl-2-oxazoline (AOx).

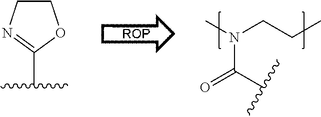

In the context of the present invention, poly(2-oxazine) polymer or copolymer is a polymer or copolymer comprising a polymer backbone derived from the ring-opening polymerization (ROP) of 5,6-Dihydro-4H-1,3-oxazine or derivatives of 5,6-Dihydro-4H-1,3-oxazine thereof. 5,6-Dihydro-4H-1,3-oxazine herein is also referred simply as 2-oxazine. In the context of the present invention, 2-oxazoline derivatives can be 2-Alkyl-2-oxazine (AOzi).

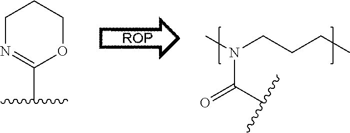

Accordingly, in a specific embodiment of the present invention, the poly(2-oxazoline) or poly(2-oxazine) backbones may also be represented by the following formulae:

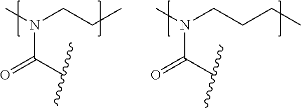

Wherein the formulae here above can be can be unified by means of the present formula Y:

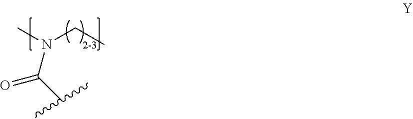

Wherein the carbon atoms for the monomeric unit, belonging to the main polymer chain, can either be 2 or 3, wherein when said atoms are 2 carbon atoms, a poly(2-oxazoline) backbone is represented, and when said atoms are 3 carbon atoms, a poly(2-oxazine) backbone is represented, and wherein the wavy bond illustrated in formula Y is attached to any other atom or molecule, such as a spacer.

In the context of the present invention, by means of the term “side chain” as used herein is meant to be to a chemical group attached to a backbone.

In the context of the present invention, by means of the term “allylamido” as used herein is meant to be a moiety having the formula depicted here below:

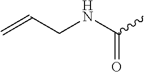

wherein the wavy bond is attached to any other atom or molecule, such as the polymer or copolymer backbone, or the spacer.

In the context of the present invention, by means of the term “cross-linker” as used herein is meant to be one or more molecules comprising a moiety which can be cross-linked according to various cross-linking methodologies, such but not limited to, thiol-ene cross-linking. Thiol-ene cross-linking refers to the polymer cross-linking technique that utilizes thiol-ene chemistry for the formation of covalent bonds polymeric network. Thiol-ene chemistry refers in broad terms to the reaction of thiol-containing compounds with alkenes, or ‘enes’. Thiol-ene chemistry are preferred in light of their multiple advantages, such as and not limited to: i) their proceeding rapidly under mild conditions, which can be made compatible with cells and other biological molecules; ii) their having well-defined and well-characterized reaction mechanisms and products; and iii) the ease of introduction of thiols and alkenes functional groups to polymers, compared to other functional groups.

In a further embodiment, the cross-linker comprises two or more thiol groups. For example, dithiothreitol can be used, further thiol containing cross-linkers which can be used in accordance with the present embodiment are: PEG-dithiol, oligoPEG-dithiol, (oligo)peptides containing 2 or more cysteine groups, further polymers with thiol-side-chains such as PEG-trithiol and PEG-tetrathiol, thiolated gelatin, PAOx with thiol side chains.

In an embodiment, the present invention provides the combination as defined herein wherein said polymer or copolymer comprises monomeric units selected from: 2-methyl-2-oxazoline, 2-ethyl-2-oxazoline, 2-propyl-2-oxazoline, 2-methyl-2-oxazine, 2-ethyl-2-oxazine and 2-propyl-2-oxzine, where 2-propyl-2-oxazoline can be selected from 2-n-propyl-2-oxazoline, 2-i-propyl-2-oxazoline and 2-c-propyl-2-oxazoline, and where 2-propyl-2-oxazine can be selected from 2-n-propyl-2-oxazine, 2-i-propyl-2-oxazine and 2-c-propyl-2-oxazine.

Accordingly, in a further embodiment, the present invention provides the combination as defined herein wherein said copolymer comprises first 2-oxazoline or 2-oxazine monomers having one or more allylamido side chains and second 2-oxazoline or 2-oxazine monomers not having allylamido side chains in a ratio from about 95-5 to 5-95, preferably from 70-30 to 10-90, more preferably 40-60 to 10-90.

Where the present invention provides copolymers, said allylamido containing 2-oxazoline monomers may be regarded as the “first” monomers. Accordingly, in the context of the present invention, by means of the term “first monomer” as used herein is meant to be a monomer of the polymer bearing an allylamido moiety at the side-chain.

In the context of the present invention, by means of the term “second monomer” as used herein is meant to be a monomer of the polymer not bearing an allylamido moiety at the side-chain.

More specifically, the polymers according to the present invention do not necessarily contain a second monomer, therefore being copolymers, but can also be homopolymers only consisting of allylamido containing monomers.

In a further embodiment of the present invention, said polymer in the combination is represented by formula (I):

(X-Z)ₙ-Y (I)
wherein:
X represents the allylamido side chain;
Z represents a direct bond or a spacer; and
Y represents the poly(2-oxazoline) or poly(2-oxazine) backbone; in particular a poly(2-oxazoline) polymer of copolymer;
and n is an integer, wherein n≥2, meaning that at least two side chains containing the allylamido moiety shall be present.

In the context of the present invention, by means of the term “backbone” as used herein is meant to be a polymer or copolymer backbone, in other words, the backbone is the longest series of covalently bonded atoms that together create the continuous chain of a polymer or copolymer. The backbones of the present invention are in particular poly(2-oxazoline) or poly(2-oxazine) backbones.

In the context of the present invention, the term “spacer” is meant to be a moiety intended to provide a (flexible) hinge between two other elements of the molecule in which it is included, thereby spatially separating said elements. Possible spacers include alkyl spacers, and elthylenoxide (PEG) spacers. The term “alkyl” by itself or as part of another substituent refers to a fully saturated hydrocarbon of Formula CₓH₂ₓ₊₁ wherein x is a number greater than or equal to 1. Generally, alkyl groups of this invention comprise from 1 to 20 carbon atoms. Alkyl groups may be linear or branched and may be substituted as indicated herein. When a subscript is used herein following a carbon atom, the subscript refers to the number of carbon atoms that the named group may contain. Thus, for example, C₁₋₄alkyl means an alkyl of one to four carbon atoms. Examples of alkyl groups are methyl, ethyl, n-propyl, i-propyl, butyl, and its isomers (e.g. n-butyl, i-butyl and t-butyl); pentyl and its isomers, hexyl and its isomers, heptyl and its isomers, octyl and its isomers, nonyl and its isomers; decyl and its isomers. C₁-C₆ alkyl includes all linear, branched, or cyclic alkyl groups with between 1 and 6 carbon atoms, and thus includes methyl, ethyl, n-propyl, i-propyl, butyl and its isomers (e.g. n-butyl, i-butyl and t-butyl); pentyl and its isomers, hexyl and its isomers, cyclopentyl, 2-, 3-, or 4-methylcyclopentyl, cyclopentylmethylene, and cyclohexyl.

For example, in the polymers/copolymers according to the present invention, Z can be an alkyl spacer, such as a C₂ alkyl or C₃ alkyl spacer. It will be clear to the skilled in the art that various spacers can be used in the context of the present invention, which selection will depend on the monomers used and the allylamido side chain provided. For example, in case the polymer in accordance with the present invention has a backbone that is a poly(2-oxazoline) backbone, and is therefore encompassed by formula Y as defined above, the first monomer is the allyl amidated 2-methoxycarboxypropyl-2-oxazoline (C3MestOx), depicted here below, and the second monomer is 2-ethyl-2-oxazoline (EtOx), not depicted, wherein m represents the number of monomeric units. Polymers/copolymers in accordance with the present invention comprise at least an allylamido side chain, in this specific case present in the first monomer. In said first monomer, X is the allylamido side chain and Z is a spacer, more specifically:

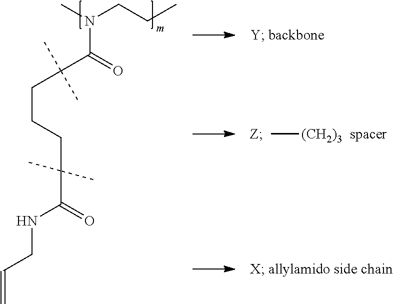

In a specific embodiment according to the present invention, said polymer or copolymer in said combination has a degree of polymerization from about 50 to 1000, preferably 100 to 800, more preferably 200 to 500. Typically, the degree of polymerization is determined by size exclusion chromatography using a multi-angle light scattering detector to determine absolute molecular weight values.

In a second aspect, the present invention provides a composition comprising a combination according to the present invention, wherein the allylamido side chain and the cross-linker are cross-linked to each other.

In a third aspect, the present invention provides a hydrogel comprising the combination or composition as described by embodiments of the present invention. The hydrogel can be obtained by cross-linking the combination to obtain a composition, and contacting the composition with a swelling agent, which is absorbed by said composition. In other words, it is hereby described a method of providing a hydrogel, comprising the step of swelling the cross-linked composition defined in accordance with the present invention, with a swelling agent. Several swelling agents can be used in the context of the present invention, such as, and not limited to: water, serum, intravenous fluids, glucose solution, Hartmann solution, stem cell solution, blood plasma, phosphate buffer, HEPES, saline solution.

In the context of the present invention, by means of the term “hydrogel” as used herein is meant to be a polymeric composition comprising a polymer network capable of absorbing or retaining a liquid within said network.

In a fourth aspect, the present invention provides for a method providing a composition in accordance with the present invention, comprising the steps of: a) providing a combination as defined by the present invention; b) curing the polymer with the cross-linker thereby obtaining said composition. The step b) of curing the polymer with the cross-linker thereby obtaining said cross-linked composition can be carried out with various techniques part of the state of the art. In accordance with a specific embodiment of the present invention, the step b) of curing is performed by means of UV-curing or thermocuring, preferably UV-curing.

Further, in a specific embodiment of the present invention, the curing step b) is accomplished in the presence of a photo initiator, such as photo initiator selected from the non-limiting list comprising 2-hydroxy-1-[4-(2-hydroxyethoxy)phenyl]2-methyl-1-propanone (Irgacure 2959), (4-benzoylphenoxy)-2-hydroxy-N,N,N-trimethyl-1-propanaminimum- chloride with methyl diethanolamine (Q-BPQ+MDEA), hydroxyalkylpropanone (APi-180), sodium and lithium salts of monoacylphosphineoxide (Na-TPO and Li-TPO), sodium and lithium salts of bisacylphosphineoxide (BAPO-OLi and BAPO-ONa). Further suitable photoinitiators not hereby described would be evident to the skilled in the art.

In a further aspect, the present invention provides a (bio)ink comprising the combination according to the present invention, and further the use of said (bio)ink for 3D printing, 2-photon polymerization, bioprinting or biomaterials.

In the context of the present invention, by means of the term “(bio)ink” as used herein is meant to be a material suitable for being shaped into a filament or droplet from e.g. by extrusion through a printing nozzle or needle, and that can possibly maintain shape fidelity after deposition.

When said material is in the form of droplets, jetting type printing techniques can be used, such as, piezoelectric jetting, thermal jetting, microvalve jetting, acoustic jetting. Alternatively, a solution of the polymer can be transformed into a crosslinked 3D object through a two-photon polymerization process.

In yet a further aspect, the present invention provides the combination, or the composition, or the hydrogel as described by other embodiments of the present invention, for use in human or veterinary medicine.

In yet a further aspect, the present invention provides the use of the combination, or the composition, or the hydrogel as described by other embodiments of the present invention, in one of: food industry, cosmetics, drug delivery, cell delivery, bio engineering applications.

More specifically, the combination, or the composition, or the hydrogel as in accordance with the present invention can be used in aesthetic procedures, large volume tissue reconstruction, small volume tissue reconstruction, fat grafting, lipofilling, burn wounds, dental applications, contact lenses, cartilage and bone tissue engineering, soft tissue engineering, such as adipose, spinal, cardiac tissue engineering, muscle and tendon tissue engineering, as a cream or ointment or gelator or thickener, as extracellular matrix mimic.

### EXAMPLE 1

In the present example, a novel allyl amidated polymer in accordance with the present invention, referred to as PEAOx, is described. The synthesis of PEAOx starts from 2-methoxycarboxypropyl-2-oxazoline (C₃MestOx), copolymerized with 2-ethyl-2-oxazoline (EtOx) followed by direct allyl amidation of the methyl ester of C₃MestOx to create a highly water-soluble polymer containing the allyl group for cross-linking. The kinetics of photo-hydrogelation and cytotoxicity of the pre-cursors are described together with the first in vivo evaluation of the FBR (foreign body response) to a PEAOx hydrogel, bench-marked with a polyethylene glycol hydrogel, to provide crucial animal safety data thereby laying the foundations for further biomaterial applications.

### Materials and Methods

All materials for the synthesis of the polymers were obtained from Merck unless stated otherwise. Polymer Chemistry Innovations kindly donated the 2-ethyl-2-oxazoline which was distilled over BaO and ninhydrin prior to use and stored in a glove box under inert and dry conditions. Synthesis of 2-phenyl-2-oxazolinium tetrafluoroborate (HPhOx-BF₄) was conducted according to the literature procedure in Monnery et al., 2018. Piperidine was distilled over CaH₂ prior to use. Dry solvents were obtained from a solvent purification system from J. C. Meyer, with aluminium oxide drying columns and a nitrogen flow. Deuterated solvent for 1H NMR spectroscopy, i.e. chloroform-d (CDCl₃, ≥99.8% D, water <0.01%), was purchased from Euriso-top. Irgacure 2959 (2-hydroxy-4′-(2-hydroxyethoxy)-2-methylpropiophenone) was a gift from BASF and was used as-received. C3MestOx was prepared according to a previously reported procedure, P. J. M Bouten et al., 2015.

### Synthesis

### Copolymerization of C₃MestOx and EtOx

Copolymerization of 2-ethyl-2-oxazoline (EtOx) with 10 mol % C₃MestOx was performed using a modified literature method, and in accordance with the synthetic scheme illustrated in FIG. 1. All glassware was cleaned and dried in a 200° C. oven before being silanized with chlorotrimethylsilane (TMS-Cl) to exclude any water from the reaction that might lead to premature termination of polymer chains and therefore an increase in polymer dispersity. Next, 2-phenyl-2-oxazolinium tetrafluoroborate salt (a, 60.6 mg, 0.258 mmol, 0.003 equiv) was added to the flask as initiator and melted under active vacuum (1.6×10⁻¹ mbar). The silanized flask was transferred under inert and dry atmosphere to a glove box, where the monomers, EtOx (7.85 mL, 77.76 mmol, 0.9 equiv) and C₃MestOx (1.29 mL, 8.64 mmol, 0.1 equiv), meaning a 9:1 ratio EtOx: C₃MestOx was used, and the dry solvent (acetonitrile, 8.87 mL) were added. The mixture was stirred firmly and a t=0 sample was taken as starting point to follow the conversion via gas chromatography (GC) and 1H-NMR spectroscopy. To obtain a P(EtOx-C₃MestOx) copolymer with a target DP of 300 at 91.5% conversion, the reaction mixture was put in an oil bath at 60° C. for 60 hours. After the reaction, 51 μL of piperidine was added at 0° C. and the resulting mixture was stirred overnight. Purification was performed by precipitation of the copolymer in ice-cold diethyl ether followed by dialysis (MWCO=3.5 kDa) and subsequent lyophilization to obtain the P(EtOx-C₃MestOx), see b, as a colourless, fluffy powder (Mw=23 kDa, Ð=1.35). Full characterization was done using gas chromatography, size-exclusion chromatography and ¹H-NMR spectroscopy.

Post-Polymerization Modification of P(EtOx90-stat-C₃MestOx10) by Direct Amidation with Allylamine

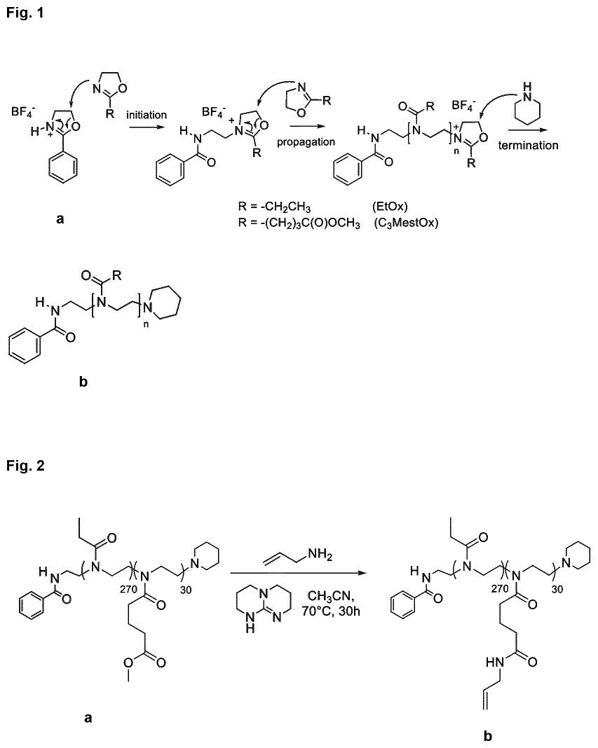

The synthesis of the allyl amidated polyoxazoline described by the present invention is illustrated in FIG. 2. The synthesized P(EtOx-C₃MestOx) copolymer contains 10 mol % (30 units) of methyl ester side chains which were functionalized in a post-polymerization modification step by amidation with allylamine. The previously synthesized P(EtOx-C₃MestOx) copolymer (a, 2 g, 0.0719 mmol), containing 2.156 mmol of functional methyl ester groups (1 equiv), was dissolved in 15.4 mL of acetonitrile with 1,5,7-triazabicyclo[4.4.0]dec-5-ene (TBD, 0.5 equiv, 1.078 mmol, 150 mg) as a catalyst. Subsequently, allylamine (6 equiv, 12.9 mmol, 0.97 mL) was added and the mixture was reacted at 70° C. for 30 hours to full conversion to PEAOx, b. The purification was performed by precipitation in ice-cold diethyl ether followed by dialysis (MWCO=1 kDa) and subsequent lyophilization. Full modification of the methyl ester side chains to allylamide side chains was confirmed using ¹H-NMR spectroscopy and size-exclusion chromatography (Mw=29 kDa, Ð=1.22).

### Characterization

### Instrumentation

Samples were measured with gas chromatography (GC) to determine the monomer conversion based on the ratio of the integrals from the monomer and the reaction solvent. GC was performed on an Agilent Technologies 7890A system equipped with a VWR Carrier-160 hydrogen generator and an Agilent Technologies HP-5 column of 30 m length and 0.320 mm diameter. An FID detector was used and the inlet was set to 250° C. with a split injection of ratio 25:1. Hydrogen was used as carrier gas at a flow rate of 2 mL/min. The oven temperature was increased with 20° C. min⁻¹ from 50° C. to 120° C., followed by a heating ramp of 50° C. min⁻¹ from 120° C. to 300° C.

Size exclusion chromatography (SEC) was performed on an Agilent 1260-series HPLC system equipped with a 1260 online degasser, a 1260 ISO-pump, a 1260 automatic liquid sampler (ALS), a thermostatted column compartment (TCC) at 50° C. equipped with two PLgel 5 μm mixed-D columns and a precolumn in series, a 1260 diode array detector (DAD) and a 1260 refractive index detector (RID). The used eluent was N,N-dimethylacetamide (DMA) containing 50 mM of LiCI at a flow rate of 0.5 mL min⁻¹. The SEC eluograms were analysed using the Agilent Chemstation software with the GPC add on. Molar mass values and D values were calculated against PMMA standards from PSS.

Lyophilisation was performed on a Martin Christ freeze-dryer, model Alpha 2-4 LSCplus.

Monomers and polymerisation mixtures were stored and prepared in a VIGOR Sci-Lab SG 1200/750 Glovebox System with obtained purity levels below 1 ppm, both for water and oxygen content.

Nuclear magnetic resonance (NMR) spectra were recorded on a Bruker Avance 400 MHz spectrometer at room temperature. ¹H NMR spectra were measured in chloroform-d (CDCl₃) purchased from Euriso-top.

### Photo-Rheology

Gelation kinetics was studied by performing small strain oscillatory shear experiments on an Anton Paar MCR302 Rheometer with 10 mm parallel plate-plate geometry at 30° C. Samples were irradiated using an Omnicure Series 1000 ultraviolet light source with 365 nm filter and a fibre optic probe fitted under the quartz bottom plate of the rheometer. An example of how the polymer sample was prepared is as follows: to make a 10% PEAOx hydrogel with 1:1 thiol to ene stoichiometry, 75 μL of a 12% wt/vol solution of PEAOx in water was mixed with 6.4 μL of a 10% DTT solution, 4.5 μL of 2% I2959 solution, and 4.1 μL distilled water to make a total of 90 μL. Aliquots of this solution (28 μL) were pipetted onto the quartz plate and the test started with the UV source turned on after either 30 or 60 sec of collecting baseline data. After irradiation samples were recovered, washed in water, freeze dried and weighed to determine swelling ratios.

### Cytotoxicity

Human foetal fibroblasts were seeded at 50,000 in Dulbecco's Modified Eagle's Medium (DMEM) supplemented with 10% foetal bovine serum (FBS), and L-glutamine (2 mM). After overnight incubation at 37° C. in 5% CO₂, culture media was changed to fresh DMEM and FBS replaced with 0.1% bovine serum albumin (BSA). H₂O₂ (200 mM; negative control) or soluble polymers (0.25 to 2 mg/mL) were added to cells in this media and incubated for 6 h. Media was discarded and cells washed in PBS before addition of CellTiter 96® AQueous MTS solution (Promega, Cat #G3582) diluted 1:10 in clear DMEM. Absorbance at 490 nm was measured after 1 h incubation. Data: mean with s.e.m expressed as percentage change of absorbance from control after background correction of MTS solution alone.

### Hydrogel Microsphere Generation

A stock solution containing PEAOx (60 mg, 1.684 mmol), dithiothreitol (DTT) (3.9 mg, 25.2 mmol, 0.5 eq. relative to the alkene of the PEAOx) was prepared in 510 μL of PBS (pH 7.3), and 30 μL 2% w/v I2959 in water was added just prior to solution being loaded into a syringe. The polymer solution was then added dropwise through a 29G needle into 10 mL of poly(dimethylsiloxane) oil stirred at 400 rpm with a 1.5 cm magnetic stirrer bar in a 25 mL round bottom flask. The suspension was then irradiated with UV light (Omnicure S2000, 365 nm) for 600 seconds with continued stirring. The resulting hydrogels spheres were washed with 200 mL of dichloromethane and filtered five times then washed with acetone (5×) and ethanol (5×) sequentially. The hydrogels were finally washed with ultrapure ethanol (1×) and sterilized PBS (5×) under aseptic conditions in a laminar hood prior to implantation into mice.

### In Vivo Determination of Foreign Body Response

The experiments involving animals were undertaken following the Australian code for the care and use of animals for scientific purposes and the Queensland University of Technology Code of Conduct for Research and were approved by the University Animal Ethics Committee. A total of six 8-week-old male C57BL/6 mice (body weights, 23±1 g) were purchased from Animal Resources Center (WA, Australia). Animals received water ad libitum and were fed with an irradiated rodent diet. Mice were housed in specific pathogen-free conditions (filtered rack, Tecniplast) under 12-hour light/dark cycles at the Medical Engineering Research Facility (Queensland University of Technology, Australia). Mice were anesthetized with isoflurane (Laser Animal Health) and subcutaneous administration of Meloxicam (1 mg/kg) and buprenorphine (0.05 mg/kg) were used as pre-emptive analgesia. In ventral recumbency, the upper and lower areas of the dorsum were clipped and painted with 10% povidone-iodine (Betadine) followed by four longitudinal incisions (approximately 3 mm) and subcutaneous pockets were formed via blunt dissection. Two hydrogel samples—two sets of 10×PEAOx spheres were placed into the pockets using forceps. The wounds were closed with sutures. Tramadol (25 mg/L) were offered in the drinking water for five days after surgery as post-operative analgesia. Mice were monitored daily for 28 days when the euthanasia was performed with CO₂ asphyxiation in an appropriate chamber, and the hydrogels samples were collected and processed for histological analysis to examine the in vivo FBR.

### Histology

Tissue explants were immersed in 4% paraformaldehyde overnight and embedded in paraffin using standard embedding protocols. Each embedded tissue sample was sectioned in 5 μm slices and stained with H&E using standard protocols.

### Results and Discussion

Copolymerization of C₃MestOx monomer with commercially-available 2-ethyl-2-oxazoline (EtOx) in a 9:1 mole ratio (9:1 EtOx: C₃MestOx) was achieved by conventional heating at 60° C. with 2-phenyl-2-oxazolinium tetrafluoroborate salt as an initiator with a target DP of 300 thereby providing P(EtOx90-stat-C₃MestOx10) copolymer, see FIG. 1 of the synthetic scheme. Size exclusion chromatography (SEC) of the copolymer revealed a dispersity of 1.35.

To introduce the allyl groups to the side-chain for thiol-ene cross-linking a simple amidation reaction with an excess of allylamine was chosen, see the synthetic scheme in FIG. 2. ¹H NMR spectroscopy confirmed the consumption of the methyl-ester and presence of the allyl groups and the secondary amine.

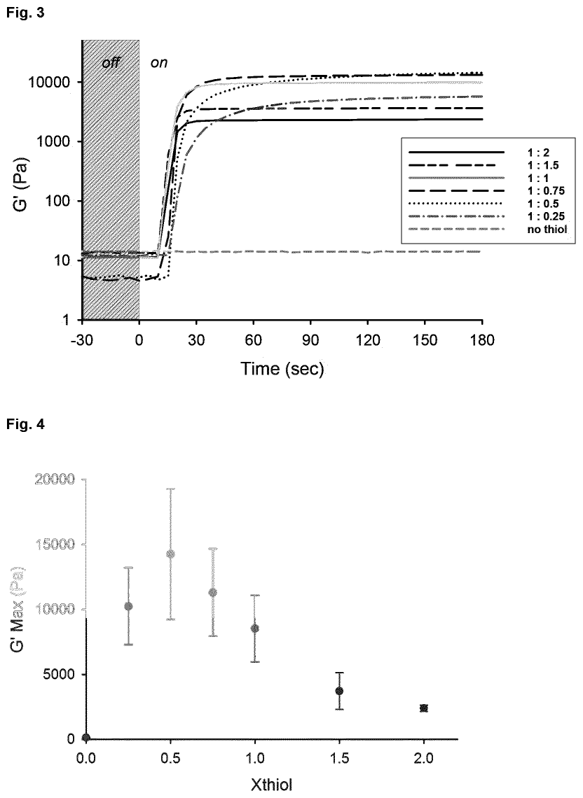

The hydro-gelation of PEAOx via thiol-ene photo-crosslinking with dithiothreitol (DTT) was investigated in real-time using rheology. The gelation kinetics showed rapid cross-linking in the order of 15 sec after illumination of the UV light, see FIG. 3, but when no thiol was used gelation was absent. FIG. 3 shows representative curves of storage moduli (G′) of 10% PEAOx solutions with different thiol:ene ratios before and during irradiation with 365 nm UV light. This is contrary to our previous findings investigating hydro-gelation of a poly(2-methyl-2-oxazoline-co-2-decenyl-2-oxazoline) copolymer where homopolymerization of vinyl groups resulted in gelation even without the thiol present. This was explained by aggregation of the hydrophobic decenyl side chains. Similar aggregation should be absent in PEAOx due to the more polar allyl-amidOx monomer thereby reducing homopolymerization. Other advantages of using allyl-amidOx is the copolymer with EtOx is water soluble; compare this with 2-decenyl-2-oxazoline copolymers in which the EtOx copolymers are water-insoluble and therefore it is limited to copolymerization with very hydrophilic monomers (e.g. MeOx) if used in aqueous systems. PEAOx also dissolves rapidly in water (within seconds) and low in surfactant-like properties meaning it is easy to pipette without generating bubbles, leading to defect-free hydrogels. By varying the ratio of thiol to ene it was observed that the final modulus was relatively insensitive to the amount of thiol used, although a maximum occurred around a mole ratio of 0.5. Further, FIG. 4 shows the dependence of thiol-ene ratio on maximum storage moduli. Presumably at higher thiol ratios there is appreciable di-sulfide bond formation, thereby reducing the storage modulus.

To test the toxicity of PEAOx human foetal fibroblasts were exposed to solutions with concentrations of up to 2 mg/mL. Based on the standard MTS metabolic assay (data not shown) the solutions were found to be non-toxic at these concentrations. This could be due to the structural similarities of PEAOx to PEtOx which is known to be non-toxic across a wide concentration range. Further, to evaluate the FBR response of cross-linked PEAOx the polymer was formulated into spherical geometry. For this study, it was chosen to prepare spheres by dropping a solution of PEAOx, DTT and I2959 into stirred silicone oil and irradiating with UV light until stable spheres were formed. All spheres were exhaustively washed with ethanol such that no silicone was detectable by NMR spectroscopy.

The size distributions of the spheres were measured using light microscopy and ranged from 0.75-1.75 mm for PEAOx spheres (data not shown). The average diameters were 1.3 mm for the PEAOx. The PEAOx of the present example consists of allylated copolymer in a 9:1 mole ratio (9:1 EtOx:C₃MestOx. The equilibrium swelling ratio of PEAOx spheres was 10.0±0.8 (n=3).

Approximately ten spheres of PEAOx hydrogels were implanted subcutaneously into immune-competent C57BL/6 mice, at four implantation sites per animal—one group per shoulder and hip. After 28 days the animals were sacrificed and the tissue around the hydrogel spheres explanted. In all cases except one the hydrogels were recovered with no visual signs of degradation (23 or 24 hydrogel implants). This lack of degradation is in contrast to Lynn et al., 2010, who recovered only 20% of 5×1 mm discs of PEG-acrylate from mice after 28 days. In their case the presence of the cleavable ester in the acrylate group was hypothesized to be the source of initial degradation products leading to macrophage recruitment and subsequent complete degradation. The PEOAx hydrogels lack degradation sites. Previous studies examining simulated biological oxidative stress have shown reactive oxygen species can degrade poly(2-ethyl-2-oxazoline). However, the good integrity of the retrieved PEAOx spheres implies the absence of substantial degradation over the time course of this experiment.

The analysis of the tissue surrounding recovered hydrogel spheres was based on fluorescence and brightfield stereomicroscopy images of spheres, and z-stacked confocal microscopy images of the same spheres. The spheres were stained for cell nuclei (DAPI), myofibroblast markers (α-smooth muscle actin, α-SMA) and F-actin. Staining of the PEAOx spheres followed by fluorescence stereomicroscopy and confocal microscopy showed the presence of a cellular deposition (DAPI, F-actin) and markers for myofibroblasts (α-smooth muscle actin, α-SMA). The presence of α-SMA implies the fibroblasts have become fibrotic (data not shown). These results clearly demonstrate the biocompatibility of the PEAOx hydrogel beads.

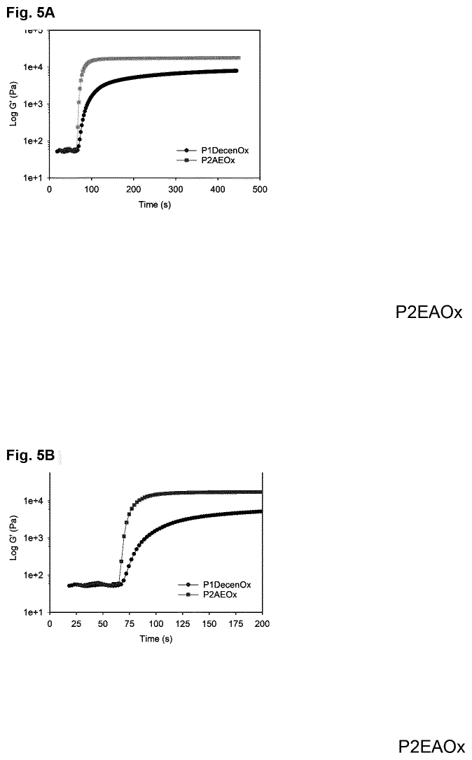

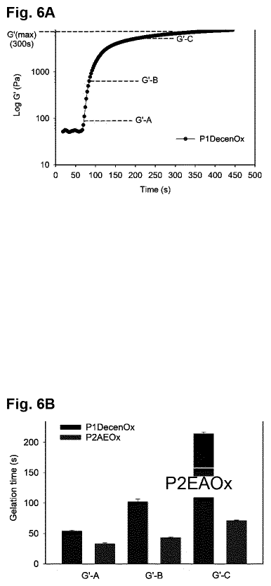

FIG. 5 and FIG. 6 show how the curing behavior of a composition according to the present invention compare to the prior art. More specifically, in FIGS. 5 and 6, it is provided a comparison between the curing behavior of PEAOx (based on 9:1 EtOx: C₃MestOx), identified in the figures as P2EAOx, and a decenyl functionalized poly(2-oxazoline), identified as P1DecenOx. The photocuring behavior has been studied under equal conditions, more specifically, at a polymer concentration of 10wt %, a ratio alkene to DDT of 1:1, and photoinitiator concentration of 0.1% of Irgacure 2959 (1-2959).

Further, samples were irradiated with 80% of Omnicure, at a 10 mm distance from tips to quartz plate. Then, the used rheometer was set to a temperature of 5° C., speed 8 rad/s and strain=0.2%.

Specifically, FIG. 5A, illustrates the photocuring behavior of a decenyl functionalized poly(2-oxazoline) (P1DecenOx) and of an allylamido containing polymer in accordance with the present invention (P2EAOx), under equal conditions in the timeframe 0 to 500 s, clearly revealing the much faster curing behavior of the latter. Then, FIG. 5B, illustrates the photocuring behavior of the same polymers and under the same conditions of the ones described in FIG. 5A, for a shorter time frame, from 0 to 200 s. Further, FIG. 6A, identify for the curing behavior of P1 DecenOx three storage modulus values, G′-A at the start of the curing, G′-B at mid-curve and G′-C before plateau the maximum storage moduli G′(max) is reached. The curve presented in FIG. 6A is also illustrated in FIG. 5A.

FIG. 6B, illustrates the difference in gelation time to reach G′-A, G′-B and G′-C as identified in FIG. 6A for P1DecenOx and P2EAOx. Based on the information illustrated in FIG. 6B, it is clear that the gelation time required by P2EAOx to reach the same storage modulus values G′-A, G′-B and G′-C is always lower than correspondent gelation time for P1 DecenOx.

### EXAMPLE 2

In addition to example 1, we have prepared copolymers of 2-methoxycarbonylethyl-2-oxazoline (C₂MestOx) with EtOx and C₂MestOx with 2-n-propyl-2-oxazoline (ⁿPrOx) using a similar procedure as described in Example 1. After amidation of these copolymers with allylamine we obtained the following allylamido functionalized copolymers, represented as P(EtOx-co-C₂AamOx) and P(ⁿPrOx-co-C₂AamOx) respectively:

| Amidated | | | | |
|---|---|---|---|---|
| copolymer | Mₙ [g/mol] (SEC) | Ð (SEC) | Total DP | Mol % allyl |
| P(EtOx-co- | 48000 | 1.15 | 300 | 10% |
| C₂AamOx) | | | | |
| P(ⁿPrOx-co- | 69800 | 1.25 | 500 | 5% |
| C₂AamOx) | | | | |

P(EtOx-co-C2AamOx) was successfully used to prepare transparent hydrogels by irradiation (365 nm) of a 10 wt % solution of the copolymer in water in presence of DTT or 2,2′-(ethylenedioxy)diethanethiol (0.5 equivalents compared to allyl groups) as crosslinker in presence of Irgacure2959 (10 mol % compared to DTT) as photoradical generator, using a similar procedure as described in example 1.

P(PrOx-co-C2AamOx) was successfully used to prepare thermoresponsive hydrogels with a volume phase transition temperature around 15° C. These hydrogels were prepared by irradiation (365 nm) of a 10 wt % solution of the copolymer in ethanol in presence of DTT (0.5 equivalents compared to allyl groups) or pentaerythritol tetrakis(3-mercaptopropionate) (0.25 equivalents compared to allyl groups) as crosslinker in presence of Irgacure2959 (10 mol % compared to DTT), using a similar procedure as described in example 1. Subsequently the ethanol was exchanged by water to obtain the hydrogel.

### EXAMPLE 3—COMPARATIVE EXAMPLE

The inventors further investigated the curing properties of other polymers comprising allyl amido side groups, which are connected to poly(2-oxazoline)s; more specifically poly(allyl acrylamides). Experiments were conducted so to compare the curing properties of poly(allyl acrylamide), see formula A at the left, and poly(pentenyl acrylamide), see formula B at the right, copolymers. More specifically copolymers having the following formula:

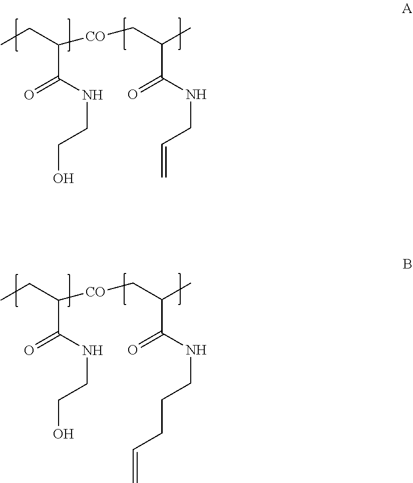

The results show that the polymers comprising pentenyl terminal double bonds crosslink faster than polymers comprising the allyl moieties. The present finding is explained by the result of hydrophobic associations of such hydrophobic cross-linkable groups (pentenyl), which determine a higher local double bond concentration, hence providing for a faster cross-linking. At the same time, these findings illustrate the presence of a surprising technical effect achieved by combinations in accordance with the present invention, wherein the polymer comprises an allylamido side chain; a cross-linker, and wherein the polymer comprises a first monomer having said allylamido side chain, the first monomer being 2-oxazoline. In particular, following the findings of the poly(allyl acrylamides) and the previous literature on poly(2-decenyl-2-oxazoline) containing polymers, a slower cross-linking rate would be expected for the more hydrophilic allylamido containing polymers. In contrast, we identified a much faster cross-linking rate for these allylamido containing poly(2-oxazoline) polymers (see example 1).

### Materials and Methods

### Materials

The following chemicals were purchased from various providers and used as received: triazabicyclodecene (TBD, 98%, TCI), ethanolamine (99%, TCI), allylamine (99%, Sigma-Aldrich), DL-Dithiothreitol (DTT) (≥98%, Sigam-Aldrich), Dowex® 50W X8 Hydrogen form strongly Acidic 50-100 Mesh (Sigma-Aldrich), acetone (>99% Sigma-Aldrich). Irgacure® 2959 was kindly donated by BASF. PMA was purchased from Scientific Polymer Products (40.08% solution in toluene, Approx. Mw: 40,000 g·mol⁻¹) 4-pentenylamine was synthetized according to a published method, see Byrne, J. et al., 2016. Deuterated water (D₂O) was purchased from Eurisotop.

### Instrumentation

A Bruker Avance 300 MHz Ultrashield was used to measure ¹H-nuclear magnetic resonance (¹H-NMR) spectra at room temperature, the chemical shifts are given in parts per million (δ) relative to tetramethylsilane. Size-exclusion chromatography (SEC) was performed on a Agilent 1260-series HPLC system equipped with a 1260 online degasser, a 1260 ISO-pump, a 1260 automatic liquid sampler (ALS), a thermostatted column compartment (TCC) set at 50° C. equipped with two PLgel 5 μm mixed-D columns (7.5 mm×300 mm) and a precolumn in series, a 1260 diode array detector (DAD) and a 1260 refractive index detector (RID). The used eluent was N,N-dimethyl acetamide (DMA) containing 50 mM of LiCI at a flow rate of 0.5 mL/min. Molar mass values and molar mass distribution, i.e. dispersity (Ð) values were calculated against Polymethylmethacrylate standards from PSS. FT-IR spectra were measured on a Perkin-Elmer 1600 series FT-IR spectrometer and are reported in wavenumber (cm⁻¹). Centrifugation was performed on an ALC multispeed refrigerated centrifuge PK 121R from Thermo Scientific using 50 ml centrifuging tubes with screw caps from VWR or 15 ml high clarity polypropylene conical tubes from Falcon. Photo-initiated thiol-ene for was performed by in-situ photocrosslinking Rheology using an Anton Paar Rheometer MCR302 equipped with a UV lamp source.

### Synthesis

### Procedure for the Preparation of A and B

PMA (0.5 g, 40 kDa, 0.0125 mmol corresponding to approx. 5.81 mmol of methyl ester group) was weighed in 5 mL flasks (5 mL microwaves tubes). Appropriate amounts of amines (for a total of 6 eq. of amine per methyl ester group) with predetermined ratio (molar ratio 1:1 or 2:1) were introduced in the flasks and the solutions were cooled to 0° C. and degassed by argon bubbling for 10 min. Flask 1A, molar ratio 2:1, ethanolamine (23.25 mmol, 1.39 mL)/allylamine (11.6 mmol, 1.03 mL). Flask 2A, molar ratio 1:1, ethanolamine (17.43 mmol, 1.04 mL)/allylamine (17.43 mmol, 1.54 mL). Flask 1B, molar ratio 2:1, ethanolamine (23.25 mmol, 1.39 mL)/4-pentenylamine (11.6 mmol, 1.16 g). Flask 2B, molar ratio 1:1, ethanolamine (17.43 mmol, 1.04 mL)/4-pentenylamine (17.43 mmol, 1.75 g). TBD (81 mg, 0.58 mmol, 0.1 eq. per methyl ester) was then added to the mixtures and the flasks were flushed with Argon, capped and heated at 80° C. over a period of 24 h. After return to room temperature, the mixtures were poured into 30 mL of cold acetone to precipitate the polymers. The solutions were centrifuged, and the liquid supernatant discarded. The polymers were further precipitated three times by dissolving in a minimal amount of methanol (2-3 mL) and pouring in cold acetone (30 mL). To remove TBD and residual traces of amines, the resultant polymers were dissolved in water, and for each sample, Dowex (160 mg, twice the mass of TBD) was added. After stirring for 5 hours and filtration to remove the Dowex, water was removed by freeze drying and the resultant solids were dried in a vacuum oven at 40° C. overnight to yield the desired pure polymers as white powders.

### Curing Experiments

In situ photo-crosslinking experiments were conducted with 10 wt % solutions of polymers in water as solvent, containing 0.5 equivalent of DDT per double bond (allyl, pentenyl groups), and a concentration of photo-initiator (Irgacure2959) of 10 mol % per DDT. The solution (around 0.4 mL) was deposit on the Rheometer glass plate and the gap was fixed at 0.4 mm (25 mm diameter upper profil). The storage and loss modulus were measured over a total period over 665 sec with a gamma amplitude for the (oscillating) shear deformation at 0.1% and a deformation frequency of 1 Hz. The baseline was measured during 1 min, then the solution were irradiated with the UV lamp (filter at 365 nm, irradiation at the bottom of the glass plate via an optical fiber) at room temperature.

### Results and Discussion

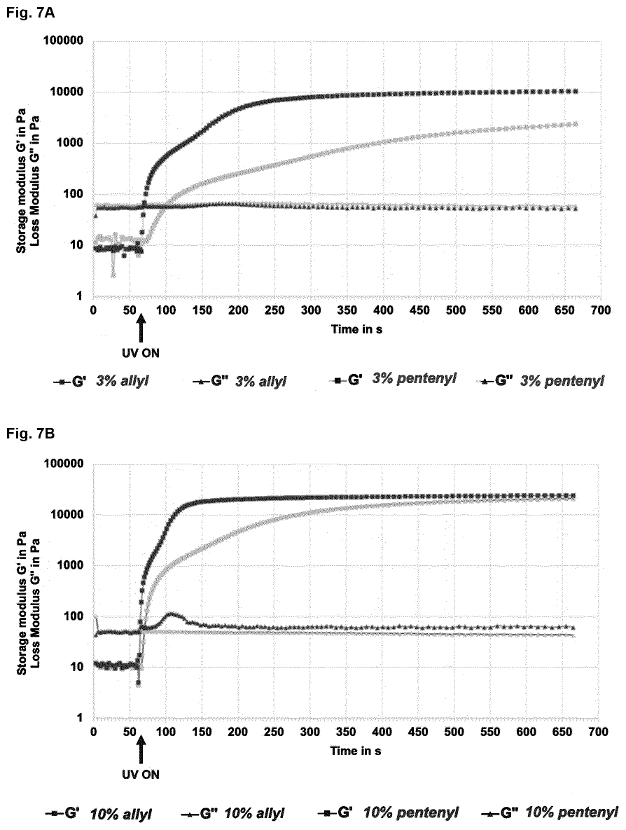

FIG. 7A and FIG. 7B illustrate results of curing experiments comparing the curing properties of poly(allyl acrylamide) and poly(pentenyl acrylamide) copolymers. More specifically, FIG. 7A and FIG. 7B illustrate values of storage modulus G′ and loss modulus G″ for a poly(allyl acrylamide) copolymer and a poly(pentenyl acrylamide) copolymer. In FIG. 7A, the alkenes tested (allyl or pentenyl) have a concentration within the polymer of 3%, measured by means of NMR, whilst in FIG. 7B, the alkenes tested (allyl or pentenyl) have a concentration within the polymer of 3%, measured also by means of NMR.

The curing experiments illustrated in FIG. 7A and 7B have been performed with a concentration of the copolymer of 10% wt, using water as solvent, 0.5 equivalent of DDT per allyl, and a concentration of photo-initiator (Irgacure) of 10% mol per DDT.

Based on the results shown in FIG. 7A and 7B, it is evident that the presence of a pentenyl moiety provides faster curing and a higher final G′ compared to the copolymer bearing the allyl moiety.

### REFERENCES

1. Hoogenboom, R. Poly(2-oxazoline)s: A polymer class with numerous potential applications. Angewandte Chemie—International Edition 48, 7978-7994, doi:10.1002/anie.200901607 (2009).
2. Dargaville, T. R., Park, J. R. & Hoogenboom, R. Poly(2-oxazoline) Hydrogels: State-of-the-Art and Emerging Applications. Macromolecular Bioscience 18, doi:10.1002/mabi.201800070 (2018).
3. Sedlacek, 0. and Hoogenboom, R. (2020), Drug Delivery Systems Based on Poly(2-Oxazoline)s and Poly(2-Oxazine)s. Adv. Therap., 3: 1900168.
4. Dargaville, Tim & Lava, Kathleen & Verbraeken, Bart & Richard, Hoogenboom. Unexpected Switching of the Photogelation Chemistry When Cross-Linking Poly(2-oxazoline) Copolymers. Macromolecules. 49. 10.1021/acs.macromol.6b00167 (2016).
5. Monnery, B. D. et al. Defined High Molar Mass Poly(2-Oxazoline)s. Angewandte Chemie—International Edition 57, 15400-15404, doi:10.1002/anie.201807796 (2018).
6. P. J. M Bouten, Dietmar Hertsen, Maarten Vergaelen, Bryn D. Monnery, Saron Catak, Jan C. M. van Hest, Veronique Van Speybroek, Richard Hoogenboom, Synthesis of poly(2-oxazoline)s with side chain methyl ester functionalities: Detailed understanding of living copolymerization behavior of methyl ester containing monomers with 2-alkyl-2-oxazolines, J. Polym. Sci., Part A: Polym. Chem., 53, 2649-2661, https://doi.org/10.1002/pola.27733 (2015).
7. Lynn, A. D., Kyriakides, T. R. & Bryant, S. J. Characterization of the in vitro macrophage response and in vivo host response to poly(ethylene glycol)-based hydrogels. J. Biomed. Mater. Res., Part A 93, 941-953, doi:10.1002/jbm.a.32595 (2010).
8. Byrne, J. P.; Blasco, S.; Aletti, A. B.; Hessman, G.; Gunnlaugsson, T., Formation of Self-Templated 2,6-Bis(1,2,3-triazol-4-yl)pyridine [2]Catenanes by Triazolyl Hydrogen Bonding: Selective Anion Hosts for Phosphate. Angewandte Chemie International Edition 2016, 55 (31), 8938-8943.

1. A composition comprising:
a polymer or copolymer having two or more allylamido side chains having the formula depicted here below: 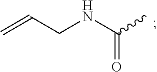
and
a cross-linker,
wherein the polymer or copolymer has a poly(2-oxazoline) or poly(2-oxazine) backbone; and
wherein the allylamido side chains of said polymer or copolymer and the cross-linker are cross-linked to each other.

2. The composition according to claim 1, wherein the cross-linker comprises two or more thiol groups.

3. The composition according to any one of claims 1 to 2, wherein the poly(2-oxazoline) or poly(2-oxazine) backbone is represented by the following formula Y:

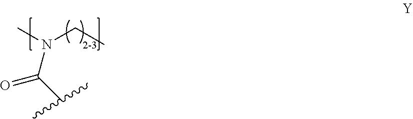

4. The composition according to claims 1 to 3, wherein said polymer or copolymer comprises monomeric units selected from: 2-methyl-2-oxazoline, 2-ethyl-2-oxazoline, 2-propyl-2-oxazoline, 2-methyl-2-oxazine, 2-ethyl-2-oxazine and 2-propyl-2-oxazine.

5. The composition according to claim 4, wherein said copolymer comprises first 2-oxazoline or 2-oxazine monomers having one or more allylamido side chains and second 2-oxazoline or 2-oxazine monomers not having allylamido side chains in a ratio from 95-5 to 5-95, preferably from 70-30 to 10-90, more preferably 40-60 to 10-90.

6. The composition according to claims 3 to 5, wherein said polymer or copolymer is represented by formula (I):
(X-Z)ₙ-Y (I)
wherein:
X represents the allylamido side chain;
Z represents a direct bond or a spacer, in particular a spacer;
Y represents the poly(2-oxazoline) or poly(2-oxazine) backbone as defined in claims 3; and
n is an integer, wherein n≥2.

7. The composition according to claims 1 to 6, wherein said polymer or copolymer has a degree of polymerization from 50 to 1000, preferably 100 to 800, more preferably 200 to 500, wherein degree of polymerization is determined by size exclusion chromatography using a multi-angle light scattering detector to determine absolute molecular weight values.

8. A hydrogel comprising the composition as described in claims 1 to 7.

9. A method for providing a composition as defined in any one of claims 1 to 7, comprising the steps of:
a) providing:
a polymer or copolymer as defined in any one of claims 1 to 7; and
a cross-linker as defined in any one of claims 1 to 2;
b) curing the polymer or the copolymer with the cross-linker thereby obtaining said composition.

10. A (bio)ink comprising a combination of:
a polymer or copolymer as defined in any one of claims 1 to 7; and
a cross-linker as defined in any one of claims 1 to 2.

11. Use of the (bio)ink according to claim 10 as an ink for 3D printing, 2-photon polymerization, bioprinting or biomaterials.

12. The composition as defined in any one of claims 1 to 7, the hydrogel as defined in claim 8, or the combination as defined in claim 10, for use in human or veterinary medicine.

13. The composition the hydrogel, or the combination according to claim 12 for use in any one of drug delivery, cell delivery, bio engineering applications.

14. Use of the composition as defined in any one of claims 1 to 7, the hydrogel as defined in claim 8, or the combination as defined in claim 10, in any one of: food industry, cosmetics.
